(19) United States
(12) Patent Application Publication
(10) Pub. No.: US 2007/0223572 A1
(43) Pub. Date: Sep. 27, 2007

(54) Method and system of pixel interleaving for improving video signal transmission quality in wireless communication

(75) Inventors: Pengfei Xia, Mountain View, CA (US); Huaning Niu, Sunnyvale, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/725,381

(22) Filed: Mar. 19, 2007

Related U.S. Application Data
(60) Provisional application No. 60/785,773, filed on Mar. 24, 2006.

(51) Int. Cl. H04B 1/66

(52) U.S. Cl. 375/240

(57) ABSTRACT

A wireless communication system for transmitting uncompressed video pixels from a transmitter to a receiver over a wireless channel is provided. The transmitter includes an interleaver that interleaves the video pixels into interleaved pixels, and an encoder that convolutionally encodes the interleaved pixels at the transmitter before transmission to the receiver. The receiver includes a decoder that decodes the encoded pixels, and a deinterleaver that deinterleaves the decoded pixels. When the video pixels include pixel errors, such interleaving and deinterleaving reduces pixel error clustering and improves video quality.

### RELATED APPLICATION

This application claims priority from U.S. Provisional Patent Application Ser. No. 60/785,773, filed on Mar. 24, 2006, incorporated herein by reference.

### FIELD OF THE INVENTION

The present invention relates to uncompressed video signal processing and, in particular, to pixel interleaving for improving video signal quality.

### BACKGROUND OF THE INVENTION

With the proliferation of wireless communication systems, it has become highly desirable to transmit video information among wireless stations. One application of wireless transmission of video is transmitting uncompressed video from a source station to a destination station wirelessly.

To provide reliable wireless transmission, convolutional codes are often used to correct channel errors due to channel fading, shadowing, noise and interference.

Although most channel errors are corrected using convolutional codes, residual pixel errors remain and tend to cluster together. Such error patterns are easily identified by human eyes and significantly degrade the perceived quality of the video.

Residual pixel error clustering may also occur when pixel partitioning is used to take advantage of spatial correlations for improving uncompressed video transmission reliability. In such cases, neighboring pixels are divided into different partitions and different partitions are transmitted as different packets separately over lossy wireless channel. At a destination station, the packets are used for reconstructing a nearby erroneous packet. However, in certain areas of a packet where the spatial correlation is not high enough, a reconstructed version is not as accurate, thereby resulting in noticeable pixel errors that typically form clustered patterns.

As such, residual pixel errors are often clustered together due to convolutional encoding or spatial reconstruction based on nearby partitions. Conventionally, to improve video quality, an additional outer code, or some stronger convolutional code, is required to correct such residual errors. Alternatively, a higher transmit power is required to provide stronger protection against hostile channel conditions. Such approaches for improving video quality add certain non-negligible operational and equipment complexity and cost. There is, therefore, a need for a method and system for improving transmission quality for uncompressed video, with reduced complexity.

### BRIEF SUMMARY OF THE INVENTION

The present invention provides a method and system for improving transmission of video pixels from a transmitter to a receiver over a wireless channel. In one embodiment, this is achieved by obtaining the video pixels from a video source, interleaving the video pixels into interleaved pixels, convolutionally encoding the interleaved pixels into encoded pixels and transmitting the encoded pixels to the receiver in units of packets (or sub packets). When the video packets/sub packets include pixel errors, interleaving reduces the pixel error clustering effect.

In one example, interleaving the video pixels into interleaved pixels further includes block interleaving the video pixels into interleaved pixels. In another example, interleaving the video pixels into interleaved pixels further includes randomly interleaving the video pixels into interleaved pixels. Yet in another example, interleaving the video pixels into interleaved pixels further includes convolutionally interleaving the video pixels into interleaved pixels.

The receiver decodes the transmitted pixels and deinterleaves the decoded pixels. Based on the interleaving process implemented at the transmitter, the deinterleaving process at the receiver can include deinterleaving the decoded pixels by block deinterleaving, random deinterleaving, convolutional deinterleaving, etc.

These and other features, aspects and advantages of the present invention will become understood with reference to the following description, appended claims and accompanying figures.

### BRIEF DESCRIPTION OF THE DRAWINGS

FIG. 1 shows a functional block diagram of a wireless communication system including a wireless transmitter and a wireless receiver that implements pixel interleaving for wireless video transmission, according to an embodiment of the present invention.

FIG. 2A shows an example of residual pixel errors that tend to cluster together as a result of convolutional decoding without pixel interleaving, or as a result of packet (sub packet) reconstruction based on pixel partitioning.

FIG. 2B illustrates an example of the effect of pixel interleaving, according to an embodiment of the present invention, wherein clustering of error pixels is substantially reduced.

FIG. 3 shows an example of block pixel interleaving, according to an embodiment of the present invention.

FIG. 4 shows an example of random pixel interleaving, according to an embodiment of the present invention.

FIG. 5 shows an example of convolutional pixel interleaving, according to an embodiment of the present invention.

### DETAILED DESCRIPTION OF THE INVENTION

The present invention provides a method and system for pixel interleaving for improving video signal transmission quality from a transmitter to a receiver over wireless communication channels. As noted, most wireless channel errors can be corrected at a receiver using convolutional codes, while certain residue pixel bit errors remain. It has been observed, however, that the residue bit errors typically form several clusters. When the erroneous bits are collected to reconstruct video pixels at the receiver, the pixel errors henceforth form clusters as well.

Accordingly, in order to reduce such clustering of pixel errors, in one embodiment the present invention provides pixel interleaving at the transmitter, and corresponding pixel deinterleaving at the receiver.

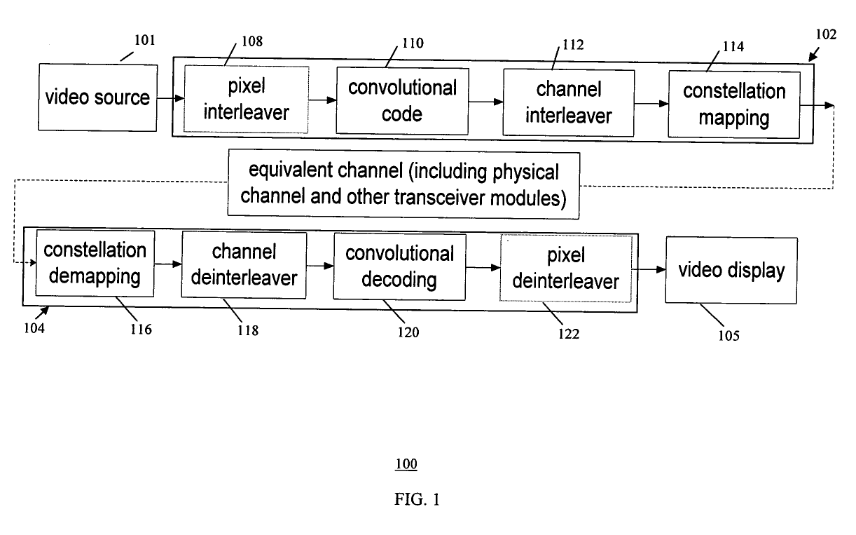

FIG. 1 shows a functional block diagram of an example wireless communication system (e.g., communication network) 100, according to the present invention, including a video source 101, a transmitter (sender) station 102, a receiver (destination) station 104 and a video sink 105 (e.g., video display). Video signals from the video source 101 are transmitted from the transmitter 102 to the receiver 104 over a wireless communication channel, for consumption by the video sink 105.

The transmitter 102 includes a pixel interleaver 108, a convolutional encoder 110, a channel interleaver 112 and a constellation mapper 114. The receiver 104 includes a constellation demapper 116, a channel deinterleaver 118, a convolutional decoder 120 and a pixel deinterleaver 122. The pixel interleaver 108 can be implemented in either a physical layer (PHY layer) or in an upper video processing layer of the transmitter 102. Similarly, the pixel deinterleaver 122 can be implemented in either a physical layer or in an upper video processing layer of the receiver 104.

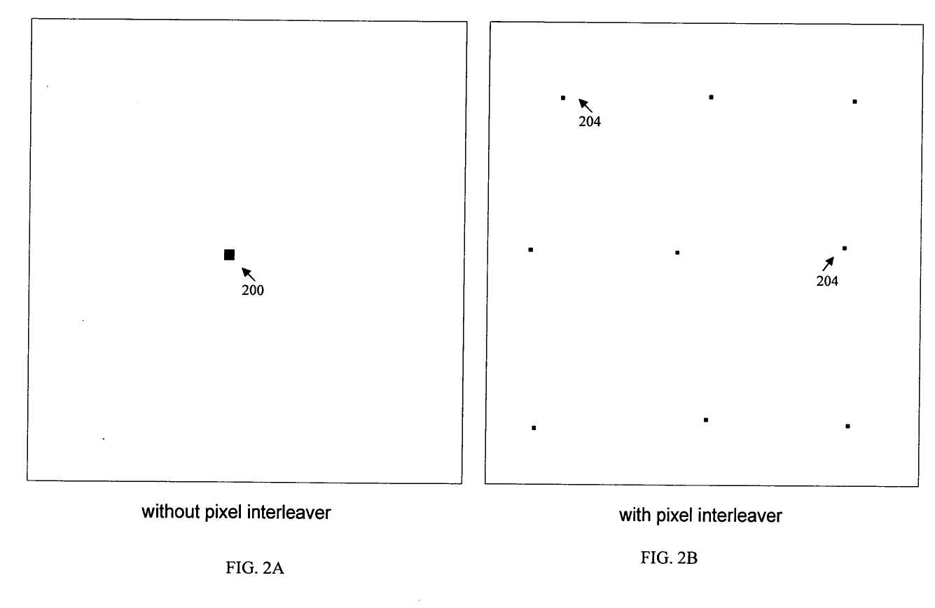

By placing the pixel interleaver 108 between the video source 101 and the convolutional encoder 110 in the transmitter 102, the pixel interleaver 108 scrambles the pixel errors such that when the transmitted pixels are deinterleaved by the pixel deinterleaver 122 at the receiver 104 and displayed on the display 105, the pixel errors are, e.g., randomly positioned, and are located far from each other. This makes the displayed pixel errors less identifiable by human eyes. This is illustrated by example in FIGS. 2A-B.

FIG. 2A shows an example of residual pixel errors that tend to form a cluster 200 as a result of convolutional decoding or as a result of spatial reconstruction, and are therefore, easily identified by human eyes. In this example, the cluster 200 includes 3×3=9 residue pixel errors. Without pixel interleaving according to the present invention, the pixel errors that form the cluster 200 are visible to the human eyes when displayed.

FIG. 2B illustrates an example of the effect of pixel interleaving according to the present invention, wherein clustering of error pixels is substantially reduced. By the action of the pixel interleaver 108 and the corresponding action of the pixel deinterleaver 122, the displayed error pixels 200 are positioned, e.g., randomly and essentially far apart from each other (spatially spread out) as pixels 204 when displayed.

Accordingly, the error pixels no longer form a cluster, and are therefore, considerably less noticeable by human eyes. This is because human eyes detect pixel errors when the error area is large enough, and the error magnitude is over a certain threshold. This is especially true when the video signal has a high resolution (hence each pixel is of a very small size) and when the video is viewed from several meters away.

The pixel interleaver 108 can be implemented in different ways. Example implementations include a block interleaver, a random interleaver and a convolutional interleaver. The pixel deinterleaver 122 in the receiver 104 is selected accordingly to perform a corresponding reverse function of the pixel interleaver 108.

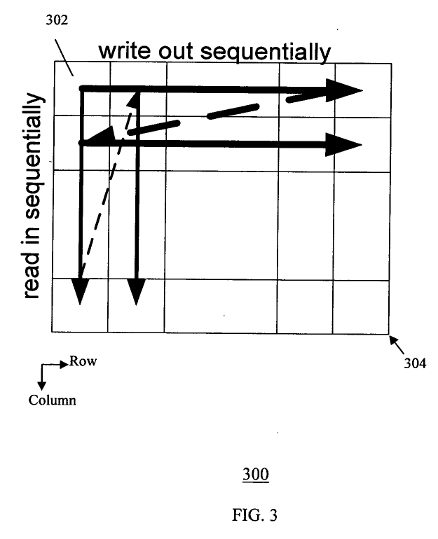

FIG. 3 shows an example block-interleaving process 300 implemented by the pixel interleaver 108, for interleaving a set of input pixels 302 in a frame that is input from the source 101. The pixels 302 are read in (input) sequentially into a buffer (memory array) 304 in a column-by-column manner (top-bottom) for interleaving, and the interleaved pixels are then written out (output) of the buffer 304 sequentially in a row-by-row manner (left-right), as shown.

A corresponding block-deinterleaving process in the pixel deinterleaver 122 of the receiver 104 restores the pixels.

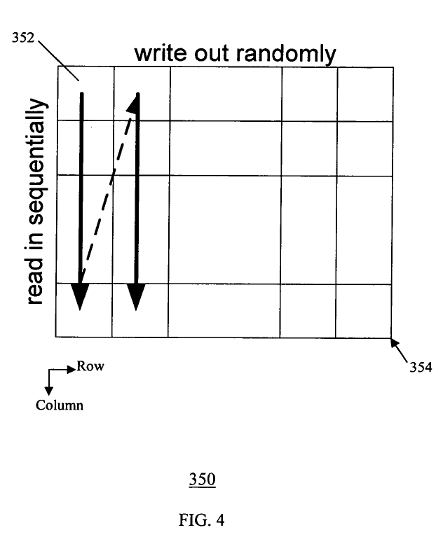

FIG. 4 shows an example random-interleaving process 350 implemented by the pixel interleaver 108, for interleaving a set of input pixels 352 in a frame that is input from the source 101. In random interleaving, there is no specific order in reading in, and writing out, the pixels.

For example, in FIG. 4, the pixels 350 can be read in sequentially into a buffer 354 but written out of the buffer 354 randomly. It is also possible to read in the pixels randomly, but write them out sequentially. It is also possible to read in pixels randomly and write out the pixels randomly. All of the operations in FIGS. 3-4 are carried out on a pixel level (not on a bit level).

A corresponding random-deinterleaving process in the pixel deinterleaver 122 of the receiver 104 restores the pixels.

In another example, a convolutional interleaving process is implemented by the pixel interleaver 108. The convolutional interleaving process rearranges the pixels in a frame such that pixels are spatially dispersed before transmission.

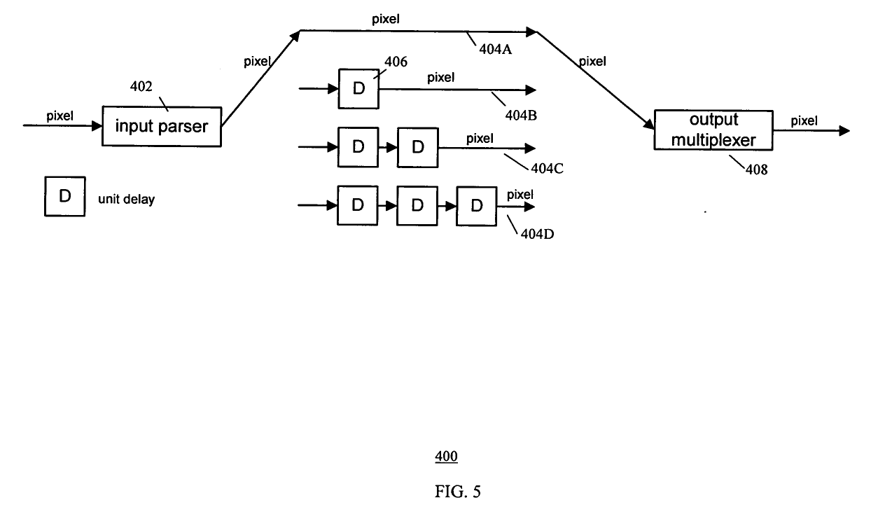

FIG. 5 shows an example convolutional interleaving process 400, wherein pixels in an input pixel stream are parsed by a parsing function 402 into multiple paths for spatial dispersion. In the example of FIG. 5, four paths 404A-D are shown, wherein the pixel on the first path 404A is not delayed, while the pixels on the subsequent paths 404B-D are delayed by D time units, 2D time units and 3D time units, respectively, where D is a positive integer.

The pixels from the different paths 404A-D are then processed by an output multiplexing function 408 that multiplexes the pixels from different paths into a pixel stream before transmission.

A corresponding convolutional deinterleaving process in the pixel deinterleaver 122 of the receiver 104 restores the spatial positions of the dispersed pixels.

Accordingly, the present invention provides a process for wireless transmission of video information, (such as uncompressed video) which reduces the clustering of pixel errors by using pixel interleaving at the transmitter, and corresponding pixel deinterleaving at the receiver.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method of transmitting video pixels from a transmitter to a receiver over a wireless channel, comprising the steps of:
obtaining video pixels from a video source;
pixel interleaving the video pixels into interleaved pixels;
convolutionally encoding the interleaved pixels into encoded pixels; and
transmitting the encoded pixels to a receiver, thereby reducing clustering of pixel errors.

2. The method of claim 1 wherein interleaving the video pixels into interleaved pixels further includes block interleaving the video pixels into interleaved pixels.

3. The method of claim 2 wherein block interleaving further includes inputting pixels sequentially into a buffer in a column-by-column manner, and outputting the pixels from the buffer sequentially in a row-by-row manner, before transmission.

4. The method of claim 1 wherein interleaving the video pixels into interleaved pixels further includes randomly interleaving the video pixels into interleaved pixels, before transmission.

5. The method of claim 1 wherein interleaving the video pixels into interleaved pixels further includes convolutionally interleaving the video pixels into interleaved pixels, before transmission.

6. The method of claim 5 wherein convolutionally interleaving includes rearranging the pixels in a frame such that pixels are spatially dispersed before transmission.

7. The method of claim 1 further comprising the steps of:
receiving the encoded pixels;
decoding the encoded pixels into decoded pixels by convolutional decoding; and
deinterleaving the decoded pixels.

8. The method of claim 7 wherein:
interleaving the video pixels into interleaved pixels further includes block-interleaving the pixels into interleaved pixels; and
deinterleaving the decoded pixels further includes block-deinterleaving the decoded pixels.

9. The method of claim 7 wherein:
interleaving the video pixels into interleaved pixels further includes randomly interleaving the pixels into interleaved pixels; and
deinterleaving the decoded pixels further includes randomly deinterleaving the decoded pixels.

10. The method of claim 7 wherein:
interleaving the video pixels into interleaved pixels further includes convolutionally interleaving the pixels into interleaved pixels; and
deinterleaving the decoded pixels further includes convolutionally deinterleaving the decoded pixels.

11. The method of claim 1 wherein the video pixels include pixel errors such that interleaving the pixels at the transmitter scrambles the pixel errors and deinterleaving the pixels at the receiver descrambles the pixels, whereby original clustered pixel errors are spatially spread apart thanks to the combined effort of pixel interleaving and pixel deinterleaving.

12. A wireless communication system, comprising:
a transmitter for wirelessly transmitting video pixels over a wireless channel, the transmitter including a pixel interleaver configured to interleave the video pixels into interleaved pixels, and an encoder configured to encode the interleaved pixels into encoded pixels for transmission over the wireless channel; and
a receiver configured to receive the encoded pixels from the channel.

13. The system of claim 12 wherein the encoder comprises a convolutional encoder configured to convolutionally encode the interleaved video pixels.

14. The system of claim 13 wherein the pixel interleaver comprises a block interleaver configured to block interleave the pixels into interleaved pixels.

15. The system of claim 13 wherein the pixel interleaver comprises a random interleaver configured to randomly interleave the video pixels into interleaved pixels.

16. The system of claim 13 wherein the pixel interleaver comprises a convolutional interleaver configured to convolutionally interleave the video pixels into interleaved pixels.

17. The system of claim 12 wherein the receiver comprises a decoder configured to decode the encoded pixels into decoded pixels, and a pixel deinterleaver configured to deinterleave the decoded pixels, wherein the pixel interleaver scrambles the pixel errors such that when the pixel deinterleaver deinterleaves the pixels for display, the pixel errors are spread apart.

18. The system of claim 17 wherein:
the pixel interleaver comprises a block interleaver configured to block-interleave the pixels into interleaved pixels; and
the pixel deinterleaver comprises a block deinterleaver configured to block-deinterleave the decoded pixels.

19. The system of claim 17 wherein:
the pixel interleaver comprises a random interleaver configured to interleave the video pixels into random interleaved pixels; and
the pixel deinterleaver comprises a random deinterleaver configured to randomly deinterleave the decoded pixels.

20. The system of claim 17 wherein:
the pixel interleaver comprises a convolutional interleaver configured to convolutionally interleave the video pixels into interleaved pixels; and
the pixel deinterleaver comprises a convolutional deinterleaver configured to convolutionally deinterleave the decoded pixels.

21. The system of claim 17 wherein the encoder comprises a convolution encoder and the decoder comprises a convolutional decoder.

22. A wireless transmitter for transmitting video pixel information over a wireless channel, comprising:
a pixel interleaver configured to interleave the video pixels into interleaved pixels; and
an encoder configured to encode the interleaved pixels into encoded pixels for transmission over the wireless channel.

23. The transmitter of claim 22 wherein the encoder comprises a convolutional encoder configured to convolutionally encode the interleaved video pixels.

24. The transmitter of claim 23 wherein the pixel interleaver comprises a block interleaver configured to block interleave the pixels into interleaved pixels.

25. The transmitter of claim 23 wherein the pixel interleaver comprises a random interleaver configured to randomly interleave the video pixels into interleaved pixels.

26. The transmitter of claim 23 wherein the pixel interleaver comprises a convolutional interleaver configured to convolutionally interleave the video pixels into interleaved pixels.

27. A wireless receiver for receiving video pixel information over a wireless channel, the video pixel information includes interleaved and encoded pixels, the receiver comprising:
a decoder configured to decode the encoded pixels into decoded pixels; and
a pixel deinterleaver configured to deinterleave the decoded pixels, whereby pixel errors are spatially spread apart.

28. The receiver of claim 27 wherein:
the pixel deinterleaver comprises a block deinterleaver configured to block-deinterleave the decoded pixels.

29. The receiver of claim 27 wherein:
the pixel deinterleaver comprises a random deinterleaver configured to randomly deinterleave the decoded pixels.

30. The receiver of claim 27 wherein:
the pixel deinterleaver comprises a convolutional deinterleaver configured to convolutionally deinterleave the decoded pixels.

31. The receiver of claim 27 wherein the decoder comprises a convolutional decoder.
